(19) United States
(12) Patent Application Publication
(10) Pub. No.: US 2026/0308954 A1
(43) Pub. Date: Oct. 8, 2026

(54) FLUSH HANDLE FOR VEHICLE DOOR

(71) Applicant: WOOBO TECH CO., LTD., Pyeongtaek-si (KR)

(72) Inventor: Hae Il JEONG, Siheung-si (KR)

(73) Assignee: WOOBO TECH CO., LTD., Pyeongtaek-si (KR)

(21) Appl. No.: 19/479,041

(22) PCT Filed: Sep. 5, 2023
(86) PCT No.: PCT/KR2023/013231

§ 371 Date: Oct. 27, 2025

(30) Foreign Application Priority Data
May 19, 2023 (KR) 10-2023-0064689

(51) Int. Cl. E05B 85/10; E05B 81/06; E05B 81/40; E05B 81/76; E05B 85/16

(52) U.S. Cl. CPC E05B 85/107; E05B 81/06; E05B 81/40; E05B 81/76; E05B 85/16

(57) ABSTRACT

The present disclosure relates to a flush handle for vehicle door disposed depending on an initial position and a popup position of a handle unit and capable of detecting through electrical energization.

### TECHNICAL FIELD

The present disclosure relates to a flush handle for vehicle door disposed depending on an initial position and a popup position of a handle unit and capable of detecting through electrical energization.

### BACKGROUND ART

A flush handle for vehicle door is a handle that opens a door by pulling an open cable 30, which is a door latch connector, and releasing a latch when a user pulls a handle unit called a knob after the handle unit is withdrawn from a retracted state (safety cable operation).

An example of the conventional flush handle for vehicle door described above is disclosed in patent document (Korean Patent No. 10-2144784).

In a flush handle for vehicle door disclosed in the patent document, while a lever 4950 rotates by pulling a handle unit (see FIG. 34) withdrawn from an initial position of the handle unit (see FIG. 33), the open cable 30 is pulled to open the closing of a latch.

The open cable 30 itself requires a large number of manufacturing processes and components.

The flush handle for vehicle door disclosed in the patent document detects the position of the handle unit by pressing a switch 23b corresponding to the initial position (see FIG. 35) of the handle unit or pressing a switch 23a corresponding to a popup position (see FIG. 36) of the handle unit depending on a movement of a moving nut 4750.

The switches 23a and 23b, as separate components, may have an installation groove in a housing or occupy a lot of space to lead to an increase in size (because the switches must be installed inside a vehicle door panel, compactness is very important).

In addition, the switches 23a and 23b are connected to wires, and thus the wiring may be exposed to the outside and may be complicated.

Since the moving nut 4750 pulls a slider 4600 in a state where a lead screw 4727 and the moving nut 4750 are placed outside a driver 4700, it may not be easy to assemble and manage, and resonance of the slider 4600 may cause noise. Further, the structures of the slider 4600 and the driver 4700 are dispersed, making modularization difficult.

### PRIOR ART DOCUMENT

### Patent Document

(Patent Document 1) Korean Patent No. 10-2144784

### DISCLOSURE OF INVENTION

### Technical Problem

An object of the present disclosure is to address the above-described and other problems.

Another object of the present disclosure is to provide a flush handle for vehicle door that is very advantageous in terms of compactness, durability, and economy through an electrical contact detection structure without using a separate switch component for detecting an initial position and a popup position of a handle unit.

Another object of the present disclosure is to provide a flush handle for vehicle door that is easy to assemble and manage by directly pulling a slider through a lead screw and a nut role structure placed inside a driver to enable modularization of the driver, and is advantageous for noise by eliminating resonance of the slider.

Another object of the present disclosure is to provide a flush handle for vehicle door that is very advantageous in reducing the cost by pushing a latch rod to open a door while a single rod descends when a popup handle unit is pulled.

### Solution to Problem

In order to achieve the above-described and other objects, in one aspect of the present disclosure, there is provided a flush handle for vehicle door comprising an electrical contact detection unit configured to detect an initial position or a popup position of a handle unit with respect to an inside of a housing through an electrical energization according to a moving position of a driver, wherein the electrical contact detection unit includes an initial position inclined lever including one end fixed to the housing and other end forming a gap with the housing, a popup position inclined lever including one end fixed to the housing and other end forming a gap with the housing, an initial position terminal of which a wire is wired inside the housing, the initial position terminal being contact energized or contact de-energized with the initial position inclined lever, and a popup position terminal of which a wire is wired inside the housing, the popup position terminal being contact energized or contact de-energized with the popup position inclined lever.

### Advantageous Effects of Invention

Effects of a flush handle for vehicle door according to the present disclosure are described as follows.

According to at least one embodiment of the present disclosure, since an electrical contact takes the form of an inclined lever and presses and energizes only in an initial position or a popup position, there is little wear due to friction, which can be advantageous in terms of durability.

According to at least one embodiment of the present disclosure, since an electrical contact detection structure using cables and terminals is adopted, a separate switch is not required, which is advantageous in terms of cost and does not occupy much space, thereby contributing to compactness.

According to at least one embodiment of the present disclosure, since a lead screw unit takes a structure that directly pulls a slider, the role of the slider and a driver becomes clearer, and modularization is possible, so assembly and management are easy, and resonance of the slider is eliminated, which can be advantageous for noise.

According to at least one embodiment of the present disclosure, it can be advantageous in cost reduction compared to cables by pushing a latch rod using one rod to open a door.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### BRIEF DESCRIPTION OF DRAWINGS

FIGS. 1, 2, and 3 are a front perspective view, a plane view, and a rear view (without a cover) illustrating an initial position of a flush handle for vehicle door according to an embodiment of the present disclosure.

FIGS. 4 and 5 are rear views enlargedly illustrating left and right sides of FIG. 3.

FIG. 6 is a cross-sectional view taken along line a-a of FIG. 4.

FIG. 7 is a front view illustrating an electrical contact detection unit when viewed from a direction A of FIG. 5.

FIGS. 8, 9, and 10 are a front perspective view, a plane view, and a rear view (without a cover) illustrating a popup position of a flush handle for vehicle door according to an embodiment of the present disclosure.

FIGS. 11 and 12 are rear views enlargedly illustrating left and right sides of FIG. 10.

FIG. 13 is a cross-sectional view taken along line b-b of FIG. 11.

FIG. 14 is a front view illustrating an electrical contact detection unit when viewed from a direction B of FIG. 12.

FIGS. 15, 16, and 17 are a front perspective view, a plane view, and a rear view (without a cover) illustrating a pull position of a flush handle for vehicle door according to an embodiment of the present disclosure.

FIGS. 18 and 19 are rear views enlargedly illustrating left and right sides of FIG. 17.

FIG. 20 is a cross-sectional view taken along line c-c of FIG. 18.

FIG. 21 is a front view illustrating an electrical contact detection unit when viewed from a direction C of FIG. 19.

FIG. 22 is a rear view of a first housing.

FIGS. 23 and 24 are perspective views illustrating the separation and coupling of a slider driver.

FIG. 25 is a separation perspective view illustrating a portion of a rod drive mechanism.

FIG. 26 is a perspective view illustrating a position of a rod drive mechanism at an initial position or a popup position.

FIG. 27 is a perspective view illustrating a position for blocking an operation of a rod drive mechanism.

FIGS. 28 and 29 are front perspective views illustrating the separation and coupling of main portions of a handle unit.

FIGS. 30 and 31 are rear perspective views illustrating the separation and coupling of main portions of a handle unit.

FIG. 32 is a front perspective view illustrating the coupling of a slider to FIG. 29.

FIG. 33 is a front perspective view illustrating an open cable 30 and a lever 4950 which are in a retracted state of a conventional flush handle for vehicle door.

FIG. 34 is a front perspective view illustrating the open cable 30 and the lever 4950 which are in a pull state after withdrawing the flush handle for vehicle door of FIG. 33.

FIG. 35 is a front view illustrating a portion of a driver in a retracted state of a conventional flush handle for vehicle door.

FIG. 36 is a front view illustrating a portion of a driver in a withdrawn state of the flush handle for vehicle door of FIG. 35.

### MODE FOR INVENTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

In the drawings, sizes of the components may be exaggerated or reduced for convenience of explanation. For example, the size and the thickness of each component illustrated in the drawings are arbitrarily illustrated for convenience of explanation, and thus the present disclosure is not limited thereto unless specified as such.

If any embodiment is implementable differently, a specific order of processes may be performed differently from the order described. For example, two consecutively described processes may be performed substantially at the same time, or performed in the order opposite to the described order.

In the following embodiments, when layers, areas, components, etc. are connected, the following embodiments include both the case where layers, areas, and components are directly connected, and the case where layers, areas, and components are indirectly connected with other layers, areas, and components intervening between them. For example, when layers, areas, components, etc. are electrically connected, the present disclosure includes both the case where layers, areas, and components are directly electrically connected, and the case where layers, areas, and components are indirectly electrically connected with other layers, areas, and components intervening between them.

In a preferred embodiment of the present disclosure, it is defined that a width direction (y-direction) of a vehicle indicates a front-rear direction, a longitudinal direction (x-direction) of the vehicle indicates a left-right direction, and a height direction (z-direction) of the vehicle indicates an up-down direction.

A flush handle for vehicle door 10 according to a preferred embodiment of the present disclosure may include a housing 100 penetrating in the front-rear direction (y-direction), a slider 200 slidably disposed inside the housing 100, a handle unit 300 slidably disposed inside the slider 200, a linear motion conversion mechanism 400 that supports to relatively enable the slider 200 to slide in the left-right direction (x-direction) and the handle unit 300 to slide in the front-rear direction (y-direction), and a rod drive mechanism 500 that pushes and opens a door latch as a rod R goes down in the up-down direction (z-direction) when pulling the popup handle unit 300 in the width direction (y-direction).

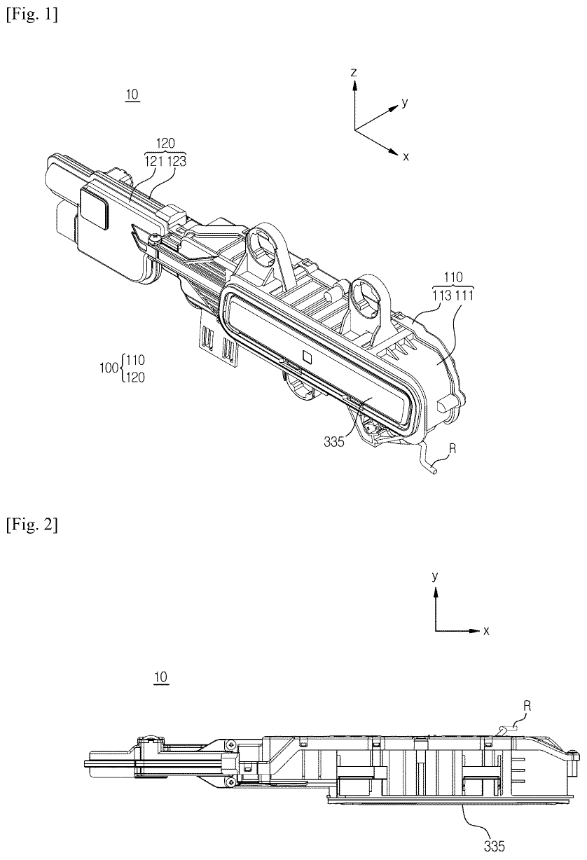

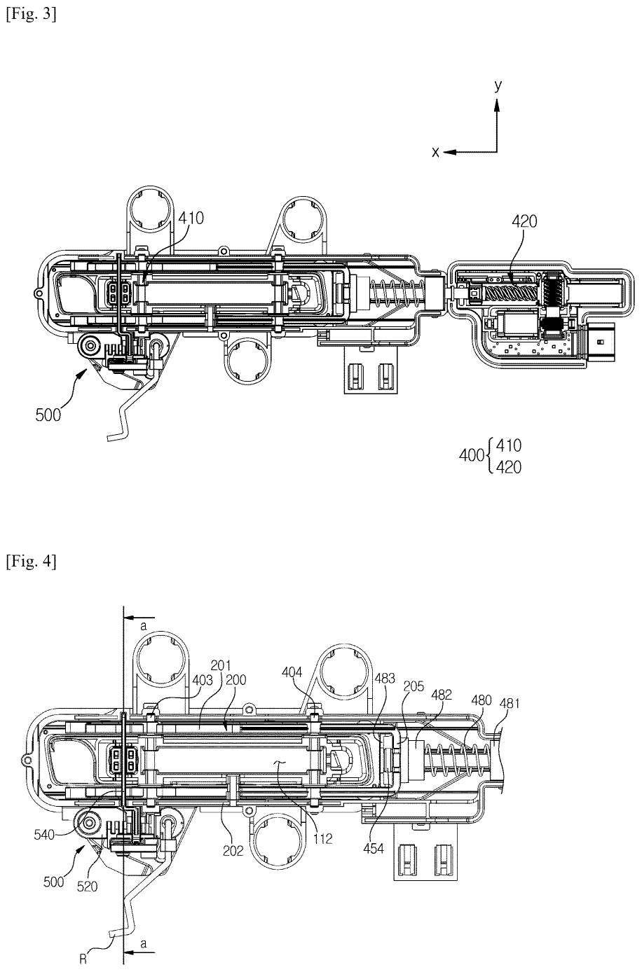

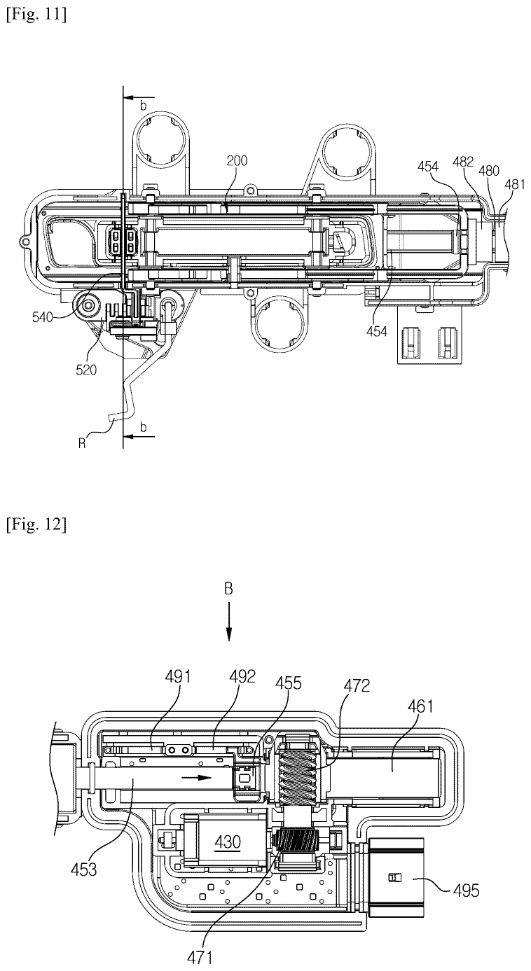

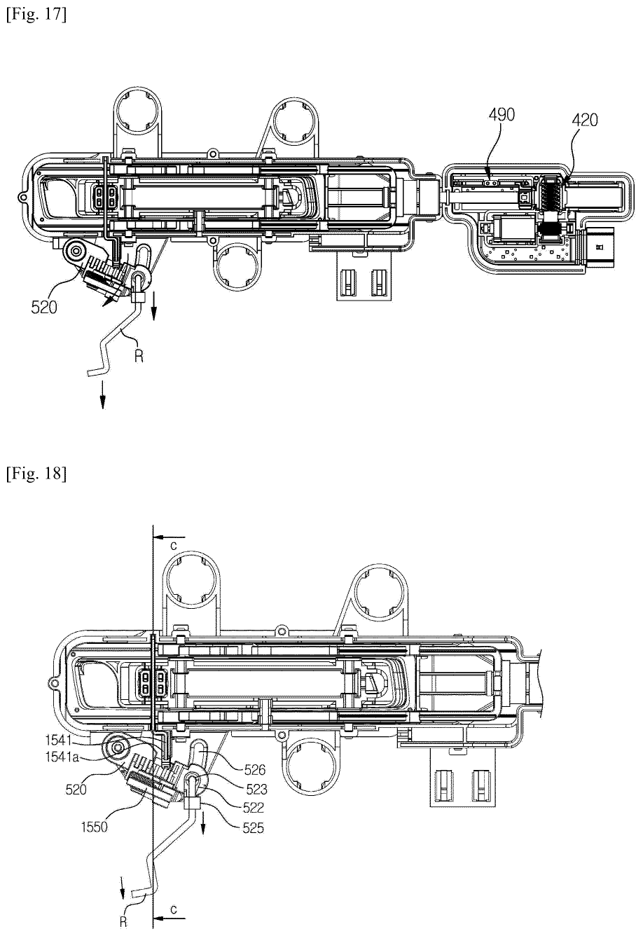

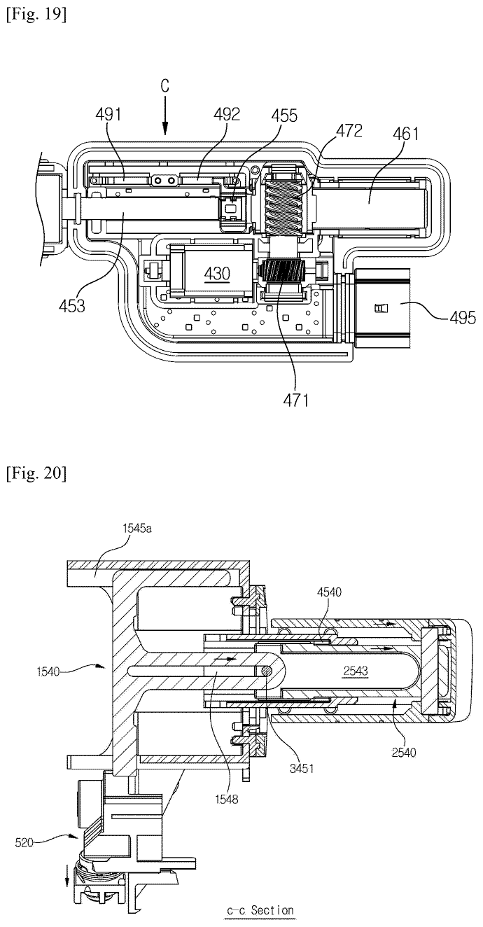

Each configuration is described in detail below with reference to FIGS. 1 to 32.

### <Housing 100>

FIGS. 1, 2, and 3 are a front perspective view, a plane view, and a rear view (without a cover) illustrating an initial position of the flush handle for vehicle door 10 according to an embodiment of the present disclosure.

Referring to FIG. 1, the flush handle for vehicle door 10 according to a preferred embodiment of the present disclosure may include the housing 100 forming an appearance. The housing 100 may be installed on a door panel (not shown).

The housing 100 may include a first housing 110. Referring to FIG. 22, the first housing 110 may include a first housing body 111. An accommodation groove 112 penetrating in the front-rear direction may be formed inside the first housing body 111. The first housing 110 may include a first housing cover 113 covering a rear surface of the first housing body 111.

The housing 100 may include a second housing 120. The second housing 120 may include a second housing body 121. The second housing 120 may include a second housing cover 123 covering a rear surface of the second housing body 121.

The first housing 110 and the second housing 120 may be fastened in series in the left-right direction as in the present embodiment, or may be integrally formed.

### <Slider 200>

The flush handle for vehicle door 10 according to a preferred embodiment of the present disclosure may include the slider 200. The slider 200 may be disposed in the accommodation groove of the first housing 110 to be slidable in the left-right direction.

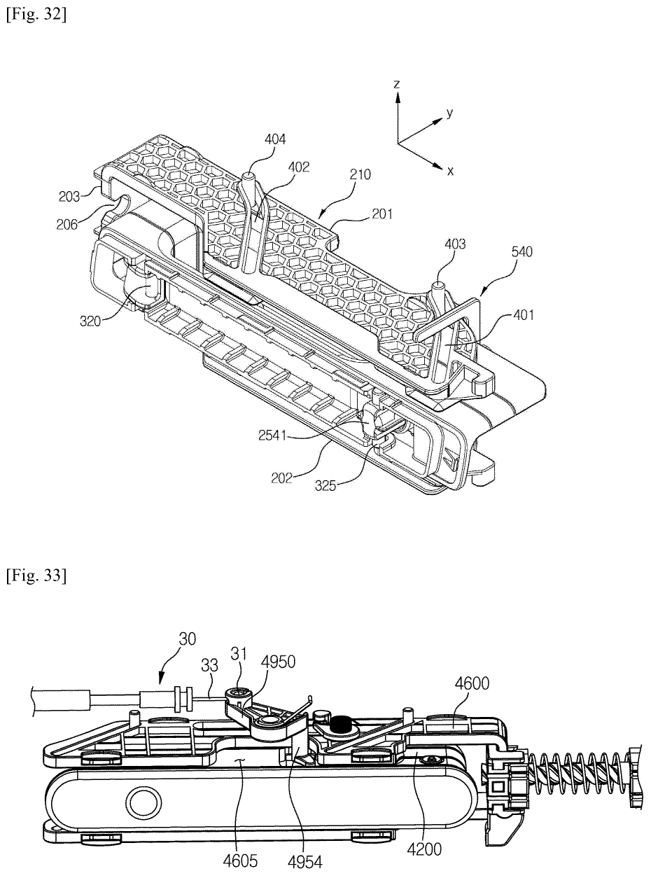

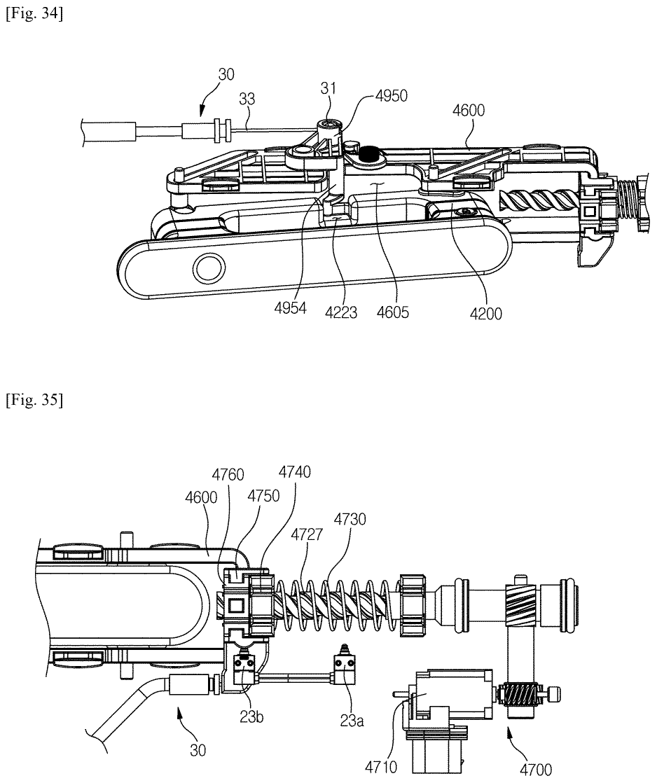

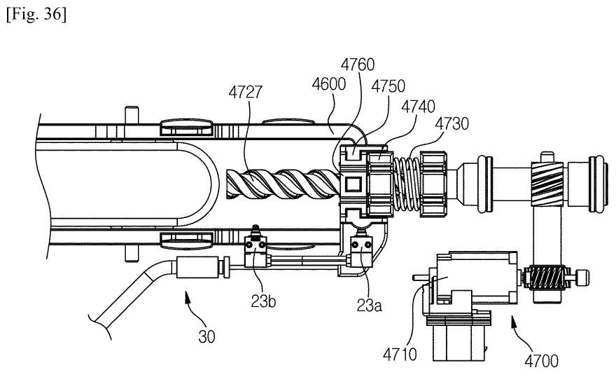

The slider 200 may include a slider body 210 as illustrated in FIG. 32. The slider body 210 may have a E-shape in which front, rear and left sides are open. That is, the slider body 210 may include an upper plate 201, a lower plate 202, and a right plate 203.

### <Handle Unit 300>

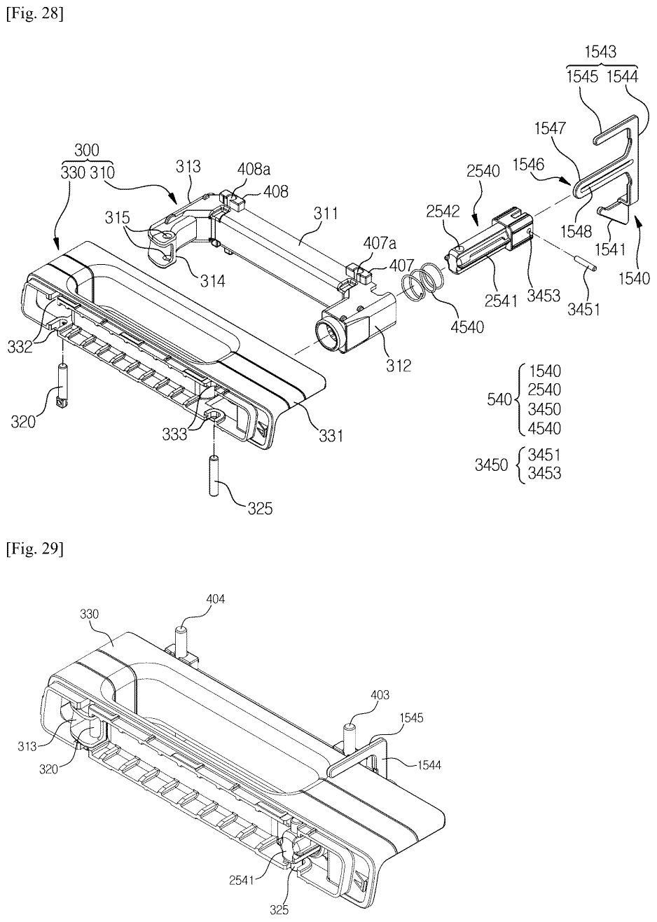

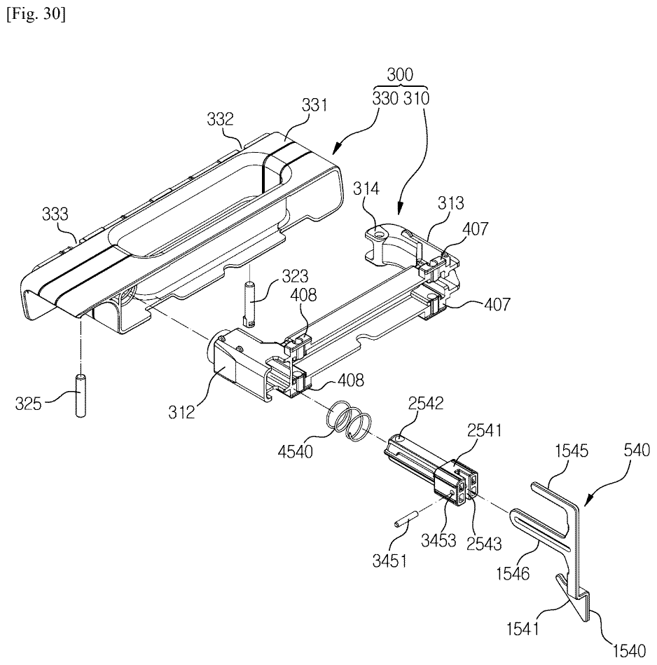

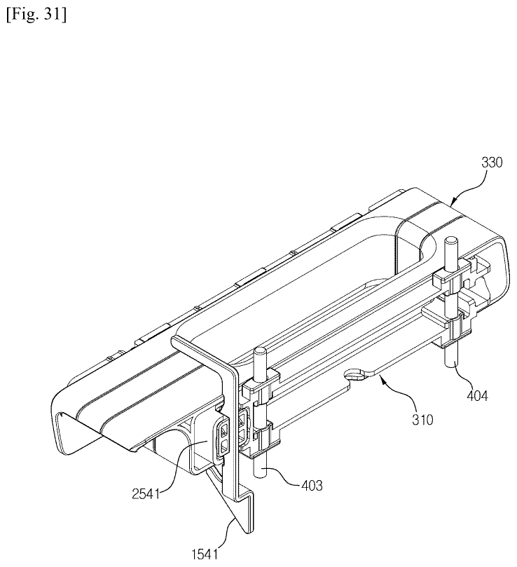

FIGS. 28 and 29 are front perspective views illustrating the separation and coupling of main portions of a handle unit. FIGS. 30 and 31 are rear perspective views illustrating the separation and coupling of main portions of a handle unit. FIG. 32 is a front perspective view illustrating the coupling of a slider to FIG. 29.

Referring to FIGS. 28 to 31, the flush handle for vehicle door 10 according to a preferred embodiment of the present disclosure may include the handle unit 300. As illustrated in FIG. 32, the handle unit 300 may be disposed inside so that the handle unit 300 can slide in the front-rear direction with respect to the left-right direction sliding of the slider 200.

The handle unit 300 may include a first handle unit 310. The first handle unit 310 may include a 1-1 handle frame 311 of the longitudinal direction. As illustrated in FIG. 30, the 1-1 handle frame 311 may have a E-shape in which a rear surface is open. The first handle unit 310 may include a 1-2 handle frame 312 and a 1-3 handle frame 313 that extend forward from both left and right ends of the 1-1 handle frame 311. The 1-2 handle frame 312 and the 1-3 handle frame 313 may have a pipe shape. A bending frame 314 bent toward the 1-2 handle frame 312 may be formed at an end of the 1-3 handle frame 313. The bending frame 314 may allow a rotation when pulling a popup second handle unit 330, which will be described later. The bending frame 314 may have a E-shape. Pinholes 315 may be formed on the top and bottom in the bending frame 314.

The handle unit 300 may include the second handle unit 330 serving as a knob. The second handle unit 330 may include a second handle frame 331 of a quadrangular shape penetrating in the up-down direction. Insertion holes into which the 1-2 handle frame 312 and the 1-3 handle frame 313 are inserted may be formed on the left and right sides of the second handle frame 331. A L-shaped insertion groove into which the 1-1 handle frame 311 is inserted may be formed on a rear surface of the second handle frame 331. Pin grooves 332 corresponding to the pinholes 315 may be formed on a front surface of the second handle frame 331. Pins 320 may be installed in the pinholes 315 and the pin grooves 332 to form a hinge that allows the second handle unit 330 to be pulled with respect to the first handle unit 310.

The second handle unit 330 may include a handle cover 335. The handle cover 335 may cover the front surface of the second handle frame 331. The handle cover 335 may serve to block an open portion of the pin groove 332.

### <Linear Motion Conversion Mechanism 400>

The linear motion conversion mechanism 400 may slide the handle unit 300 in the front-rear direction with respect to the left-right direction sliding of the slider 200, or may slide the slider 200 in the left-right direction with respect to the front-rear direction sliding of the handle unit 300.

The linear motion conversion mechanism 400 may include a linear motion conversion unit 410. The linear motion conversion unit 410 may guide to enable the relative sliding of the slider 200 and the handle unit 300. The linear motion conversion unit 410 may be slidably disposed in the accommodation groove 112 of the first housing 110.

Referring to FIG. 32, the linear motion conversion unit 410 may include first and second inclined slot holes 401 and 402. The first and second inclined slot holes 401 and 402 may be inclined so that they face up and down on the left and right sides of the upper plate 201 and the left and right sides of the lower plate 202 of the slider 200.

The linear motion conversion unit 410 may include first and second vertical pins 403 and 404. The first and second vertical pins 403 and 404 may slide along the first and second inclined slot holes 401 and 402. As illustrated in FIGS. 31 and 32, the first and second vertical pins 403 and 404 may be inserted into first and second pinholes 407a and 408a of the first handle unit 310. The first and second pinholes 407a and 408a may be formed on a rear surface of the 1-1 handle frame 311. The first and second pinholes 407a and 408a may be formed in hooking pieces 407 and 408 that are caught on the rear surface of the 1-1 handle frame 311.

In addition, the top and bottom of the first and second vertical pins 403 and 404 may slide along first and second guide grooves 405 and 406. As illustrated in FIG. 22, the first and second guide grooves 405 and 406 may be formed on upper and lower inner walls of the first housing body 111 along the front-rear direction.

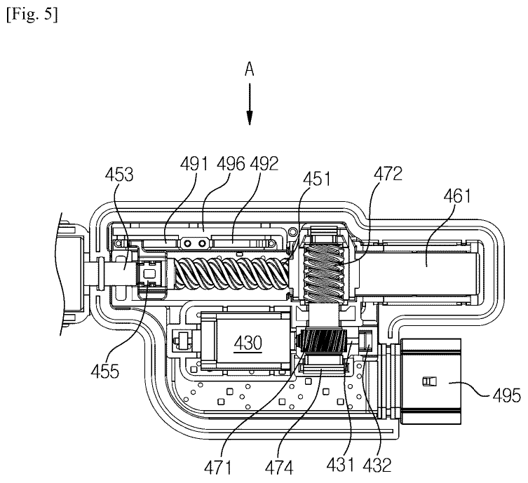

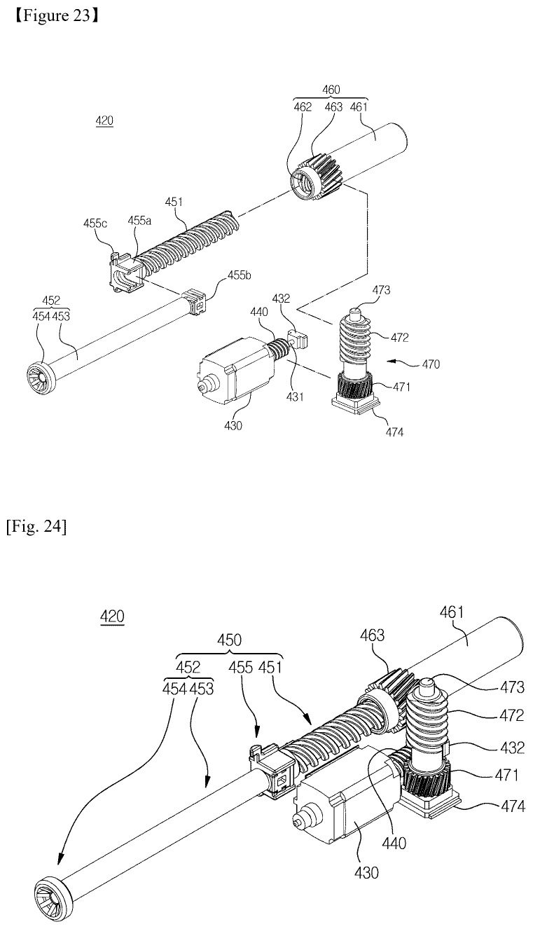

Referring to FIGS. 23 and 24, the linear motion conversion mechanism 400 may include a slider driver 420. The slider driver 420 may pull the slider 200 to the right. As illustrated in FIG. 5, the slider driver 420 may be mounted on the second housing 120.

The slider driver 420 may include a motor 430. A free end of a rotating shaft 431 of the motor 430 may be rotatably supported by a bearing 432. The bearing 432 may be installed in the second housing 120 in a non-rotating manner.

The slider driver 420 may include a drive worm 440. The drive worm 440 may be installed on the rotating shaft 431 of the motor 430 or integrally molded to the rotating shaft 431.

The slider driver 420 may include a driven lead screw unit 450. The driven lead screw unit 450 may pull the slider 200 rightward.

The driven lead screw unit 450 may include a driven lead screw 451. The driven lead screw 451 may include a male threaded rod.

The driven lead screw unit 450 may include a pull bar 452. The pull bar 452 may be pulled by a popup amount of the handle unit 300.

The pull bar 452 may include a rod 453 and a flange 454 formed at a left end of the rod 453. A left side of the rod 453 may be mounted on a clip 206, which is a C-shaped mounting groove formed on a right plate 205 of the slider 200 illustrated in FIG. 32. Then, the flange 454 may be disposed inside the right plate 205 of the slider 200. A diameter of the flange 454 may be much larger than the clip 206.

The driven lead screw unit 450 may include a direct connection piece 455 directly connecting the driven lead screw 451 and the rod 453. The direct connection piece 455 may include a first direct connection piece 455a formed at a left end of the driven lead screw 451 and a second direct connection piece 455b formed at a right end of the rod 453. The first direct connection piece 455a may include female polygon grooves, and the second direct connection piece 455b may include male polygon grooves. The polygonal shape can prevent the rod 453 from wandering with respect to the rotation of the driven lead screw 451. A first uneven portion may be formed on an inner perimeter surface of the female polygon groove, and a second uneven portion coupled to the first uneven portion may be formed on an outer perimeter surface of the male polygon groove. A pressing protrusion 455c may be formed on the direct connection piece 455 to press an electrical contact detection unit 490 described later. The pressing protrusion 455c may protrude forward from one side of the first direct connection piece 455a.

The slider driver 420 may include a screw bushing 460. The screw bushing 460 may be rotatably mounted on the second housing 120. The screw bushing 460 may include a cylinder 461. The screw bushing 460 may include a female screw 462 fastened to the driven lead screw 451. The female screw 462 may be formed on an inner circumferential surface of the cylinder 461 along the longitudinal direction. The female screw 462 may be screwed into the driven lead screw 451. The screw bushing 460 may include a gear 463. The gear 463 may be a tooth formed on an outer circumferential surface of the cylinder 461. The gear 463 may be configured as a helical gear.

The slider driver 420 may include an intermediate gear 470. The intermediate gear 470 may transfer rotational power of the drive worm 440 to the screw bushing 460. The intermediate gear 470 may also be rotatably installed in the second housing 120. The intermediate gear 470 may include an intermediate worm gear 471 meshing with the drive worm 440 and an intermediate helical worm 472 meshing with the gear 463. The intermediate worm gear 471 and the intermediate helical worm 472 may be formed on the same rotating shaft 473. A bearing 474 may also be installed at a lower end of the rotating shaft 473. The bearing 474 may be installed in the second housing 120 in a non-rotating manner.

Referring to FIG. 4, the slider driver 420 may include a return spring 480. The return spring 480 may apply an elastic force to return the slider 200 when the handle unit 300 is retracted or the driven lead screw unit 450 moves to the left. The return spring 480 may be installed between the right plate 205 of the slider 200 and the first housing 110. The return spring 480 may be stably installed between a right seat 481 and a left seat 482. The return spring 480 may include a compression spring.

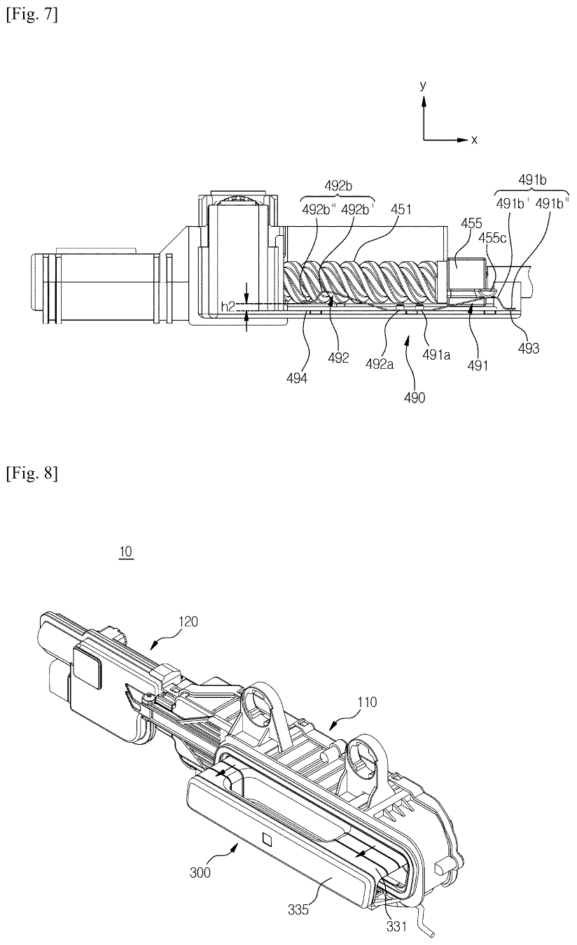

Referring to FIGS. 7, 14, and 21, the slider driver 420 may include the electrical contact detection unit 490. The electrical contact detection unit 490 may detect an initial position or a popup position of the handle unit 300.

The electrical contact detection unit 490 may include an initial position inclined lever 491. As illustrated in FIG. 14, a right side 491a of the initial position inclined lever 491 may be fixed to the second housing 120, and a left side 491b of the initial position inclined lever 491 may float so that a gap h1 is formed between the left side 491b and the second housing 120. The left side 491b of the initial position inclined lever 491 may include an upward convex arc-shaped pressing piece 491b′ and a foot 491b″. The foot 491b″ may have a plate shape horizontal toward the outside of the pressing piece 491b′. The foot 491b″ may be energized/de-energized by attaching to and detaching from an initial position terminal 493.

The electrical contact detection unit 490 may include a popup position inclined lever 492. As illustrated in FIG. 7, a left side 492a of the popup position inclined lever 492 may be fixed to the second housing 120, and a right side 492b of the popup position inclined lever 492 may float so that a gap h2 is formed between the right side 492b and the second housing 120. The gap h2 may be substantially the same as the gap h1. The right side 492b of the popup position inclined lever 492 may include an upward convex arc-shaped pressing piece 492b′ and a foot 492b″. The foot 492b″ may have a plate shape horizontal toward the outside of the pressing piece 492b′. The foot 492b″ may be energized/de-energized by attaching to and detaching from a popup position terminal 494.

The electrical contact detection unit 490 may include the initial position terminal 493 and the popup position terminal 494 of a wire 496 wired inside the second housing 120. The initial position terminal 493 and the popup position terminal 494 are connected to a connector 495 via the wire 496. The connector 495 may be installed outside one side of the second housing 120.

Accordingly, when the pressing protrusion 455c is on the left side as illustrated in FIG. 7, the left side 491b of the initial position inclined lever 491 is pressed and contacts the initial position terminal 493, making it energized. On the other hand, the right side 492b of the popup position inclined lever 492 is not pressed and detects de-energization.

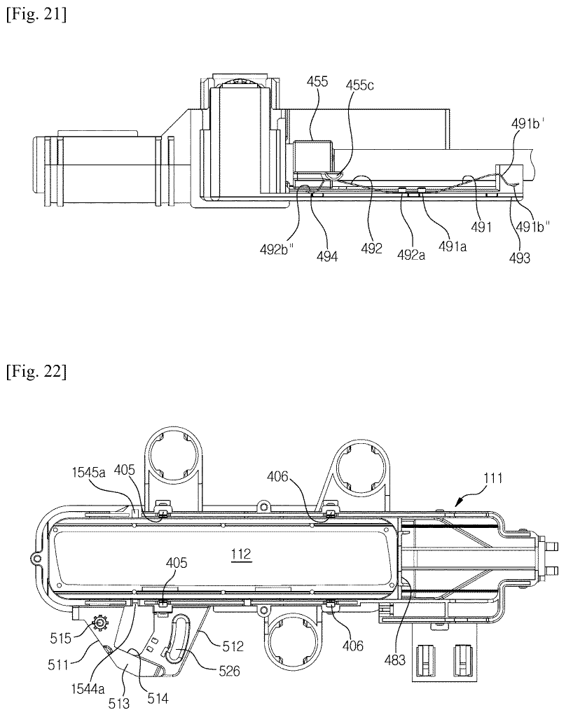

When the pressing protrusion 455c is on the right side as illustrated in FIGS. 14 and 21, the right side 492b of the popup position inclined lever 492 is pressed and contacts the popup position terminal 494, making it energized. On the other hand, the left side 491b of the initial position inclined lever 491 is not pressed and detects de-energization.

As above, when the pressing protrusion 455c moves to the left and right, only floating portions such as the left side 491b of the initial position inclined lever 491 and the right side 492b of the popup position inclined lever 492 are pressed, thereby preventing de-energization and reduction of a recognition rate by eliminating a phenomenon of part grinding due to continuous friction.

The initial position inclined lever 491 and the popup position inclined lever 492 may detect the initial position and the popup position of the handle unit 300 through electrical energization by arranging a brass plate terminal depending on the position.

The initial position inclined lever 491 and the popup position inclined lever 492 may form a pair.

### <Rod Drive Mechanism 500>

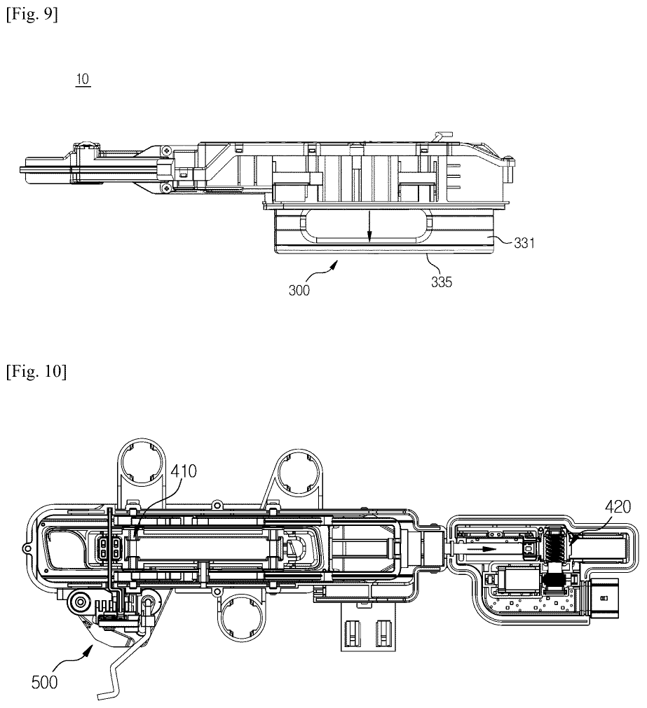

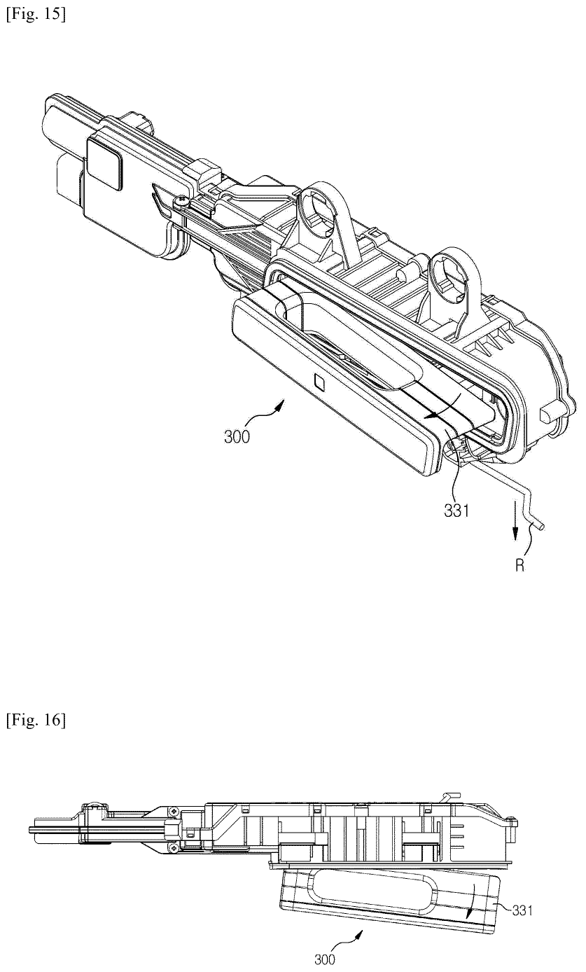

When the rod drive mechanism 500 pulls the popup handle unit 300 as illustrated in FIGS. 8 and 9 forward as illustrated in FIGS. 15 and 16, while the rod R goes down, the door latch (not shown) may be pushed downward and opened as illustrated in FIG. 18.

Since the rod R is a steel rod and operates as a single steel rod, it can be very advantageous in cost reduction compared to the conventional open cable 30, and the layout can be simpler and cleaner than the open cable 30.

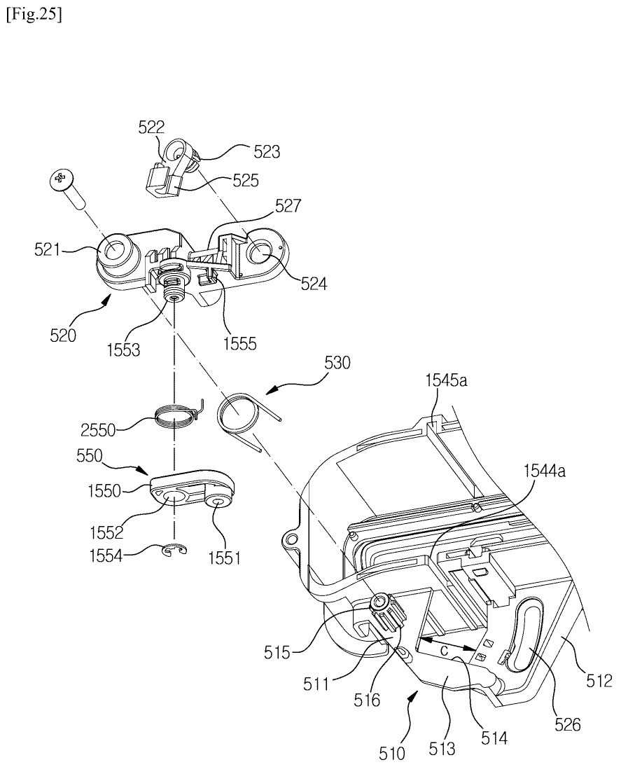

Referring to FIGS. 22 and 25, the rod drive mechanism 500 may include a bracket 510. The bracket 510 may be formed on a lower surface of the first housing body 111.

The bracket 510 may include a first bracket 511 and a second bracket 512 extending downward from a lower plate of the first housing body 111, and an inclined bracket 513 inclined downward from a lower end of the first bracket 511 toward a lower end of the second bracket 512. The first bracket 511 may protrude rearward more than the second bracket 512. Therefore, by forming a gap c between the first bracket 511 and the second bracket 512, an upper surface 514 of the inclined bracket 513 may serve as a lower limit stopper on which a lower surface of a pivot lever 520 to be described below is caught. It is obvious that the lower plate of the first housing body 111 may serve as an upper limit stopper of the pivot lever 520. A support shaft 515 protruding toward the rear may be formed on the first bracket 511. A line contact protrusion 516 may be formed along a perimeter on an outer perimeter surface of the support shaft 515.

The rod drive mechanism 500 may include the pivot lever 520. A rotation bush 521 fitted to the support shaft 515 may be formed on a left side of the pivot lever 520. A rod mounting piece 522 may be installed on a right side of the pivot lever 520. A rotating shaft 523 protruding forward may be formed on an upper side of the rod mounting piece 522. The rotating shaft 523 may be rotatably installed in a rotation hole 524 formed on the right side of the pivot lever 520. A rod clip 525, on which the rod R is mounted, may be formed on a lower side of the rod mounting piece 522. The rotating shaft 523 may move up and down along an arc groove 526 formed up and down in the second bracket 512.

The rod drive mechanism 500 may include a torsion coil spring 530. The torsion coil spring 530 may be a return spring that elastically presses the pivot lever 520 upward with respect to the bracket 510.

Referring to FIGS. 18 and 20, the rod drive mechanism 500 may include a rod driver 540. The rod driver 540 may descend the pivot lever 520 by pulling forward the popup handle unit 300.

Referring to FIGS. 28 and 30, the rod driver 540 may include a rod drive piece 1540. The rod drive piece 1540 may be installed in the first housing 110 so as to be slidable in the front-rear direction. The rod drive piece 1540 may be made of a metal or non-metal material.

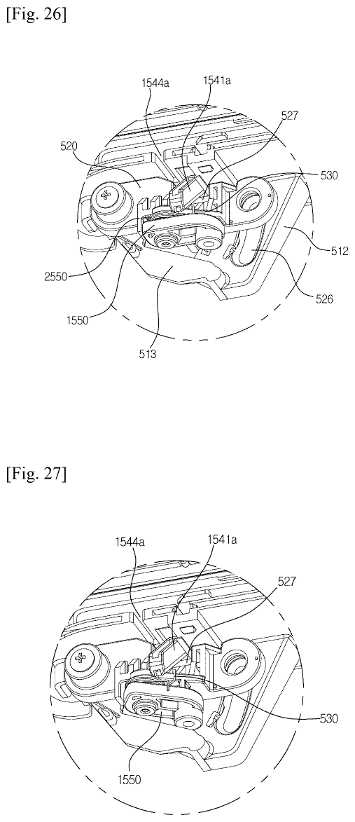

The rod drive piece 1540 may include an inclined piece 1541. The inclined piece 1541 may have a triangular shape. An inclined surface 1542 of the inclined piece 1541 may be disposed on or contact an upper side 527 of the pivot lever 520. As illustrated in FIGS. 26 and 27, a case 1541a may be covered on the inclined piece 1541. The case 1541a is a plastic material and can minimize wear resulting from a relative motion with the upper side 527 of the pivot lever 520.

The rod drive piece 1540 may include a support piece 1543. The support piece 1543 may be installed in the first housing 110 so as to be slidable in the front-rear direction. The support piece 1543 may include a vertical support piece 1544 supporting the inclined piece 1541 at its lower end. Referring to FIG. 22, a lower side of the vertical support piece 1544 may be slidably disposed in a cutout groove 1544a formed in the lower plate of the first housing 110. The support piece 1543 may include a horizontal support piece 1545. The horizontal support piece 1545 may protrude forward from an upper end of the vertical support piece 1544. The horizontal support piece 1545 may be disposed in a guide groove 1545a formed in the front-rear direction on an inner wall of the upper plate of the first housing 110. The guide groove 1545a may be arranged in parallel with the first and second guide grooves 405 and 406.

The rod drive piece 1540 may include a slot hole piece 1546. The slot hole piece 1546 may include an extension piece 1547 extending forward between the horizontal support piece 1545 and the inclined piece 1541, and a slot hole 1548 formed in the extension piece 1547 in a horizontal direction. The slot hole piece 1546 may have a length that protrudes forward more than the horizontal support piece 1545.

Referring to FIGS. 28 to 31, the rod driver 540 may include a sliding unit 2540. The sliding unit 2540 may be disposed inside one side of the first handle unit 310 so as to be slidable in a pulling direction.

The sliding unit 2540 may include a sliding bar 2541. The sliding bar 2541 may be slidably disposed on one side of the first handle unit 310. A pinhole 2542 may be formed in front of the sliding bar 2541. As illustrated in FIG. 29, pins 325 may be installed in a pin groove 333 and a pinhole 2542 formed on the front surface of the second handle frame 331, and the second handle unit 330 and the sliding unit 2540 may be pulled together.

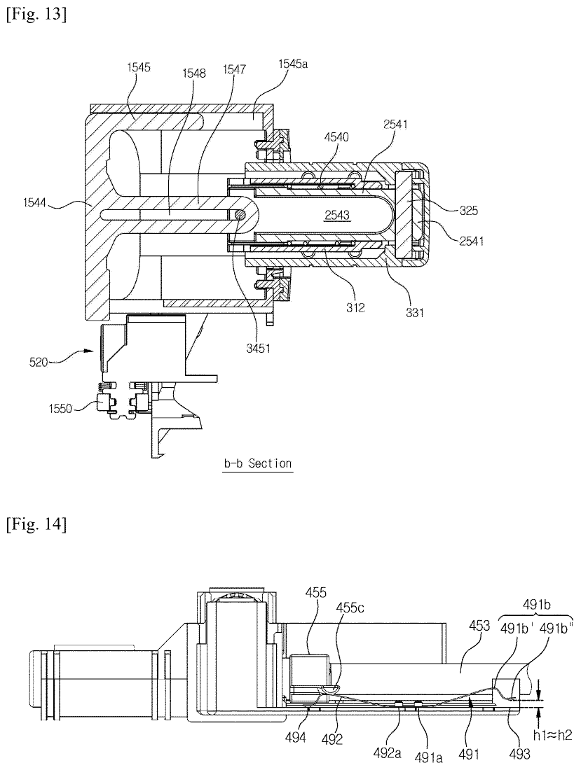

Referring to FIG. 13, the sliding unit 2540 may include a slot hole groove 2543. The slot hole groove 2543 may be formed inside the sliding bar 2541 toward the front from a rear surface of the sliding bar 2541. The slot hole piece 1546 may be slidably inserted into the slot hole groove 2543.

The rod driver 540 may include a pull interlocking piece 3540. As illustrated in FIG. 20, the pull interlocking piece 3450 may also pull the rod drive piece 1540 in conjunction with the pull of the sliding unit 2540. The pull interlocking piece 3450 may include a horizontal pin 3451. The pull interlocking piece 3450 may include horizontal pinholes 3453 formed on the left and right sides of the sliding bar 2541. Therefore, the horizontal pin 3451 may be disposed on the slot hole 1548 of the slot hole piece 1546 through the horizontal pinhole 3453.

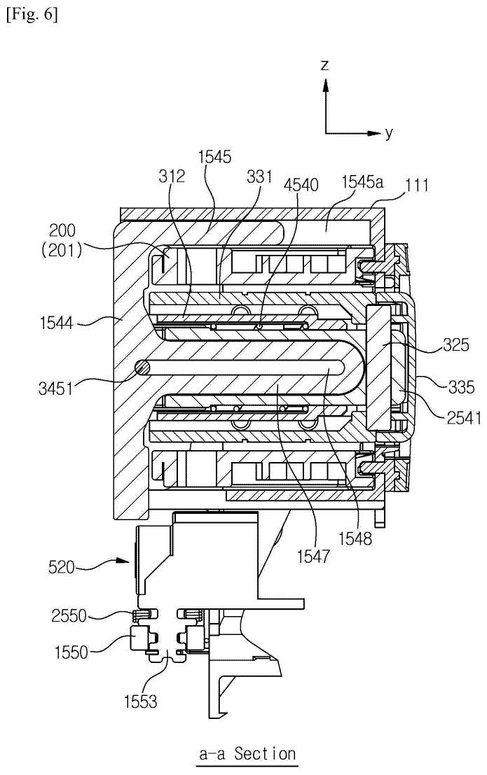

Referring to FIGS. 6 and 28, the rod driver 540 may include a compression coil spring 4540. When the pull is released, the compression coil spring 4540 may return the pulled sliding unit 2540 with respect to the first handle unit 310.

The rod drive mechanism 500 may include a rod non-driver 550. When an impact is applied to the vehicle door, the rod non-driver 550 may prevent the descending of the pivot lever 520 resulting from the impact. That is, the rod non-driver 550 can prevent the pivot lever 520 from descending when a weight balance 1550 of FIG. 26 enters a distance c between the first bracket 511 and the second bracket 512 (see FIG. 27).

Referring to FIG. 25, the rod non-driver 550 may include the weight balance 1550. The weight balance 1550 may include a weight 1551 that shifts the center of gravity to one side. The weight balance 1550 may include a rotation hole 1552 penetrating up and down. The rotation hole 1552 may be rotatably installed on a support shaft 1553 formed on a lower surface of the pivot lever 520. The weight balance 1550 may not fall downward due to a C-ring 1554 assembled to the support shaft 1553. In addition, a guide rib 1555 may protrude downward at the lower surface of the pivot lever 520. The guide rib 1555 may serve as a guide so as not to move up and down when the weight balance 1550 rotates.

The rod non-driver 550 may include a torsion coil spring 2550. The torsion coil spring 2550 may be installed between the lower surface of the pivot lever 520 and an upper surface of the weight balance 1550. The torsion coil spring 2550 may apply an elastic force to the weight balance 1550 outward (forward) with respect to the pivot lever 520. Therefore, normally, the torsion coil spring 2550 does not interfere with the operation of the pivot lever 520, and the weight balance 1550 does not prevent the pivot lever 520 from descending.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

[Description of reference numerals]

| | |
|---|---|
| 10: flush handle for vehicle door | 100: housing |
| 200: slider | 300: handle unit |
| 310, 330: first and second handle unit | 400: linear motion conversion |
| mechanism | |
| 410: linear motion conversion unit | 420: slider driver |
| 430: motor | 440: drive worm |
| 450: driven lead screw unit | 460: screw bushing |
| 470: intermediate gear | 480: return spring |
| 490: electrical contact detection unit | 500: rod drive mechanism |
| 510: bracket | 520: pivot lever |
| 530: torsion coil spring | 540: rod driver |
| 1540: rod drive piece | 2540: sliding unit |
| 3540: pull interlocking piece | 4540: compression coil spring |
| 550: rod non-driver | 1550: weight balance |
| 2550: torsion coil spring | |

1. A flush handle for vehicle door comprising:
an electrical contact detection unit configured to detect an initial position or a popup position of a handle unit with respect to an inside of a housing through an electrical energization according to a moving position of a driver,
wherein the electrical contact detection unit includes:
an initial position inclined lever including one end fixed to the housing and other end forming a gap with the housing;
a popup position inclined lever including one end fixed to the housing and other end forming a gap with the housing;
an initial position terminal of which a wire is wired inside the housing, the initial position terminal being contact energized or contact de-energized with the initial position inclined lever; and
a popup position terminal of which a wire is wired inside the housing, the popup position terminal being contact energized or contact de-energized with the popup position inclined lever.

2. The flush handle for vehicle door of claim 1, wherein a connector to which the wires are connected is installed outside the housing.

3. The flush handle for vehicle door of claim 2, further comprising:
a slider slidably disposed inside the housing; and
a linear motion conversion unit configured to support to enable a front-rear direction sliding of the handle unit with respect to a left-right direction sliding of the slider,
wherein the driver slidably drives the slider.

4. The flush handle for vehicle door of claim 3, wherein the driver includes:
a motor;
a drive worm installed on a rotating shaft of the motor;
a driven lead screw unit configured to pull the slider in a right direction;
a screw bushing including a female screw fastened to the driven lead screw unit and a gear formed on an outer circumferential surface; and
an intermediate gear configured to transfer a rotational power of the drive worm to the gear of the screw bushing.

5. The flush handle for vehicle door of claim 4, wherein the driven lead screw unit includes:
a pull bar configured to pull the slider;
a driven lead screw fastened to the female screw of the screw bushing;
a direct connection piece configured to directly connect the pull bar and the driven lead screw; and
a pressing protrusion formed on the direct connection piece,
wherein the pressing protrusion presses the other end of the initial position inclined lever or the other end of the popup position inclined lever to contact and energize the initial position terminal or the popup position terminal.
